(19) United States
(12) Patent Application Publication
(10) Pub. No.: US 2009/0327943 A1
(43) Pub. Date: Dec. 31, 2009

(54) IDENTIFYING APPLICATION PROGRAM THREATS THROUGH STRUCTURAL ANALYSIS

(75) Inventors: Ivan Medvedev, Bellevue, WA (US); Adam Shostack, Seattle, WA (US); Lawrence William Osterman, Woodinville, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,581

(22) Filed: Jun. 26, 2008

(51) Int. Cl. G06F 21/00; G06F 3/048

(52) U.S. Cl. 715/772; 726/25

(57) ABSTRACT

Identifying threats to an information system by analyzing a structural representation of the information system. In some embodiments, a data flow diagram corresponding to the information system is analyzed based on predefined criteria. Potential threats to elements of the data flow diagram are identified based on the predefined criteria. The threats are prioritized and provided to a user for further testing. In an embodiment, the user performs fuzz testing of application programs in the information system based on the prioritized threats.

### BACKGROUND

Traditional software development includes several separate activities such as gathering requirements, determining specifications, designing, test planning, implementing, and implementation testing. Test planning includes, for example, security design analysis. However, there is often an undesirable conceptual separation between security design analysis and security testing.

Existing methods for security testing include “fuzz” testing. Fuzz testing is the automatic generation of input data for an application program or other process to test the application program in terms of functionality, reliability, stability, response under stress, and more. An objective in fuzz testing is to generate input data that uncovers programming errors that could lead to security problems.

Successful fuzz testing, however, is a time-consuming process involving significant, frequent, and manual intervention by a tester. It is often unclear which portions of an application should be tested and at what level, as well as which variations of input data should be generated. As a result, fuzz testing is often misapplied or omitted entirely, leaving the application program potentially vulnerable to security problems.

### SUMMARY

Embodiments of the invention identify security testing targets for an information system through structural analysis of a threat model for the information system. In some embodiments, a representation of the information system is analyzed. The representation includes a data flow diagram having a plurality of elements arranged to describe a flow of data through the elements. The elements may be associated with one or more application programs in the information system. The data flow diagram is analyzed according to predefined criteria to identify one or more of the elements that may pose a threat. A threat priority is assigned to the identified elements. The identified elements and the assigned threat priorities are provided to a user as potential security testing targets for further investigation. In an embodiment, the predefined criteria include data flow elements that cross trust boundaries and communicate with an external data source.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user interacting with a threat modeling system.

FIG. 2 is an exemplary block diagram of a computing device having a memory area storing a representation of a data flow diagram.

FIG. 3 is an exemplary flow chart illustrating a structural analysis of an application program based on predefined criteria.

FIG. 4 is an exemplary flow chart illustrating execution of a threat modeling system.

FIG. 5 is an exemplary flow chart illustrating the identification of security testing targets and the assignment of threat priorities to elements of an application program.

FIG. 6 is an exemplary user interface illustrating a data flow diagram with a marked trust boundary.

FIG. 7 is an exemplary user interface illustrating recommend fuzz targets.

Corresponding reference characters indicate corresponding parts throughout the drawings.

### DETAILED DESCRIPTION

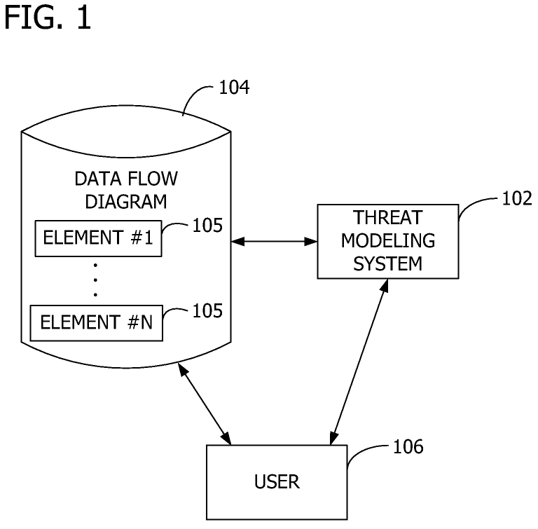

Embodiments of the invention identify security threats to an information system or process. In some embodiments, the security threats are identified through a structural analysis of the information system. In a testing environment such as shown in FIG. 1 in which the information system includes an application program, a data flow diagram 104 corresponding to the application program is analyzed by a threat modeling system 102 based on predefined criteria. The threat modeling system 102 identifies elements 105 of the data flow diagram 104 that pose potential security threats to the application program. The potential security threats are reported to a test engineer or other user 106 and, in some embodiments, the identified, potential security threats are used as fuzz targets for testing. While aspects of the invention are discussed with reference to identifying security testing targets for the application program, aspects of the invention are operable generally with information systems including a plurality of application programs, processes, and data stores.

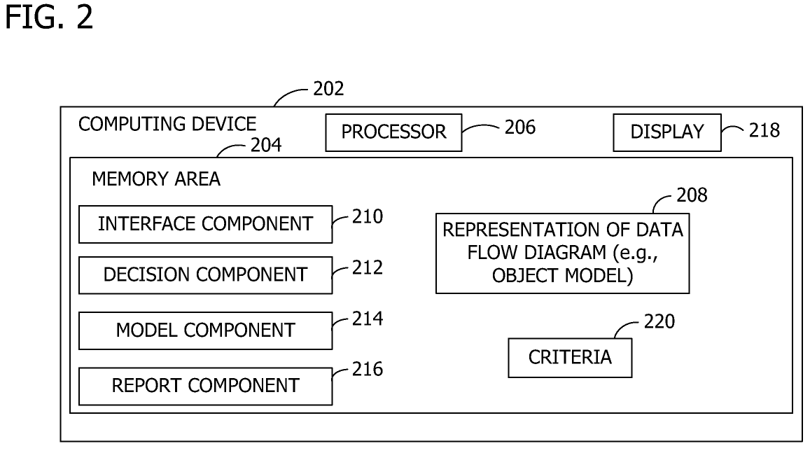

Referring next to FIG. 2, an exemplary block diagram shows a computing device 202 having a memory area 204 storing a representation 208 of an exemplary data flow diagram such as data flow diagram 104 from FIG. 1. The computing device 202 has a memory area 204 and at least one processor 206. In an embodiment, the processor 206 is transformed into a special purpose microprocessor by executing computer-executable instructions or by otherwise being programmed. For example, the memory area 204 or other computer-readable medium stores computer-executable components for identifying security testing targets for the application program. Exemplary components include an interface component 210, a decision component 212, a model component 214, and a report component 216.

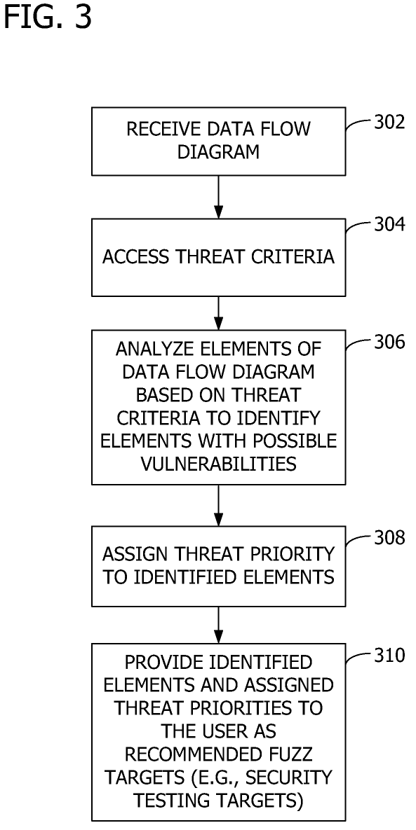

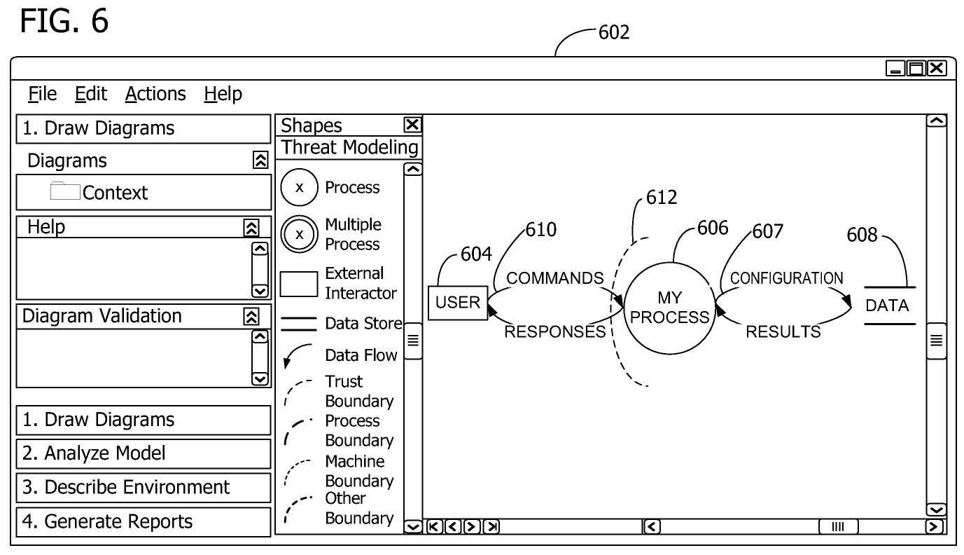

The components in FIG. 2 execute computer-executable instructions such as those illustrated in FIG. 3. The interface component 210 receives the representation 208 of the data flow diagram 104 for the application program at 302. The memory area 204 stores the representation 208 as, for example, an object model having a set of classes and objects, in an extensible markup language (XML) or other format, or other data structure. The data flow diagram 104 comprises a plurality of the elements 105 such as element #1 through element # N, where N is a positive integer. The plurality of elements 105 is arranged to describe operation of the application program. The interface component 210 further accesses one or more threat criteria or other criteria 220 for identifying potential threats to the application program at 304. The criteria 220 are stored in the memory area 204, for example, or are otherwise accessible by the decision component 212. The criteria 220 may be predefined, input by the user 106, be generated automatically based on heuristics or historical threat data, or otherwise created or generated. The criteria 220 may also identify a particular category of the elements 105 to analyze. Exemplary element categories include data flow elements, data store elements, process elements, and external interactor elements such illustrated in FIG. 6 below.

The decision component 212 analyzes each of the plurality of elements 105 based on the criteria 220 accessed by the decision component 212 to identify one or more of the plurality of elements 105 at 306. The identified elements represent elements that are more likely to contain vulnerabilities than other elements in the application program. The model component 214 assigns a threat priority to each of the one or more of the plurality of elements 105 identified by the decision component 212 at 308. The report component 216 provides at 310 to the user 106 the one or more of the plurality of elements 105 identified by the decision component 212 and the threat priority assigned by the model component 214 as security testing targets.

Alternatively, the model component 214 merely indicates one or more of the plurality of elements 105 identified by the decision component 212 as potential vulnerabilities in the information system. The indicated elements represent security testing targets. In such embodiments, a threat priority is not assigned.

In some embodiments, the report component 216 automatically selects at least one of the identified elements as a target for fuzz testing based on the assigned threat priority, if any of the identified elements are reasonable targets for fuzz testing. In other embodiments, none of the identified elements is selected as a target for fuzz testing. Alternatively or in addition, the user 106 evaluates the identified elements, and may select one or more of the identified elements as targets for fuzz testing.

In some embodiments, the interface component 210 provides the plurality of elements 105 identified by the decision component 212 and the threat priority assigned by the model component 214 in a security testing priority report for display on a display 218. For example, the interface component 210 provides the information in the security testing priority report as a sorted, or user-sortable, list of suggested, recommended, or possible security testing targets for display on the display 218. The list of possible security testing targets may be organized hierarchically based on the assigned threat priority to emphasize critical threats over non-critical threats (e.g., critical threats listed first). Alternatively or in addition, the possible security testing targets may be color-coded or otherwise visually distinguishable based on the assigned threat priority. The term “critical” refers to a severity or importance of the security testing target. The severity or importance may be subjective, objective, absolute, or relative to other targets, and may be set by the user 106, original equipment manufacturer (OEM), or other entity.

The interface component 210 may also provide the representation 208 of the data flow diagram 104 along with the assigned threat priority value for each of the elements 105 identified by the decision component for display on the display 218. For example, the threat priority values may be visually indicated on a visual representation of the data flow diagram 104 (e.g., the identified elements may be color-coded or otherwise visually distinguished within the data flow diagram 104). The user 106 interacts with the data flow diagram 104, for example, by filtering the possible security testing targets based on their threat priority values. In some embodiments, the user 106 selects an option to only display, or highlight, the possible security testing targets having a particular threat priority value or range of threat priority values.

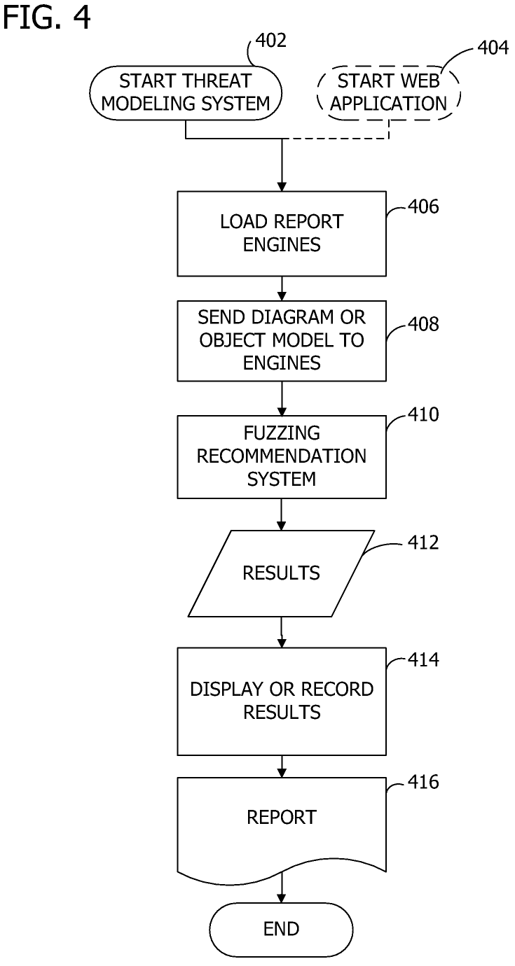

Referring next to FIG. 4, an exemplary flow chart illustrates execution of an example of the threat modeling system 102. The threat modeling system 102 starts at 402 as an application executing on a computer associated with the user 106. In other embodiments, the threat modeling system 102 is a web application executing remotely from the user 106 at 404. Report engines are loaded at 406. The report engines include, for example, applets or plug-ins providing the functionality described and illustrated herein. The data flow diagram 104 or object model representing the data flow diagram 104 are sent to the report engines at 408. A fuzzing recommendation system executes at 410. The fuzzing recommendation system is included in the loaded report engines in an embodiment, and includes the functionality illustrated and described with reference to FIG. 3, for example. Results are output at 412. The results include the elements in the data flow diagram 104 that represent threats and potential vulnerabilities in the application program. The results are displayed or recorded at 414. A report is stored to memory such as the memory area 204 at 416. The user 106 is then able to focus testing efforts on the elements listed in the report.

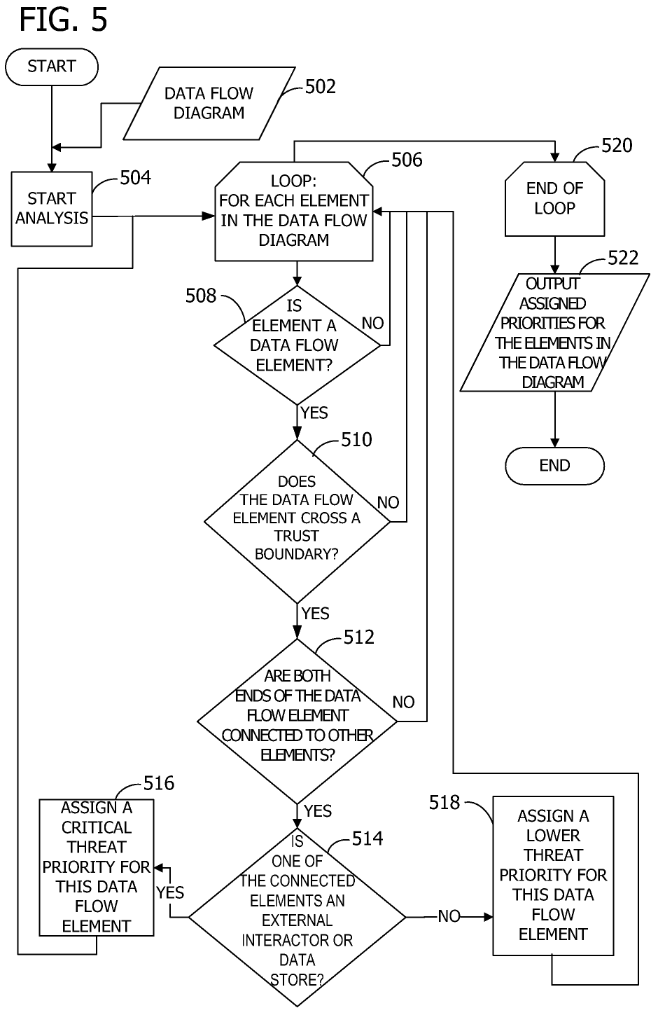

Referring next to FIG. 5, an exemplary flow chart illustrates the identification of security testing targets and the assignment of threat priorities to the elements 105 of the application program. The data flow diagram 104 or threat model is accessed at 502 at the start of the analysis at 504. The plurality of elements 105 in the data flow diagram 104 is arranged to describe operation of the application program. Each of the plurality of elements 105 in the data flow diagram 104 is analyzed in a loop at 506. A critical threat priority is assigned for the element 105 at 516 if the element 105 is a data flow element at 508, crosses a trust boundary at 510, is well-formed at 512 (e.g., both ends of the element 105 are connected to other elements 105), and is connected to an external interactor element or data store at 514. The data flow element represents a transmission of data from a first one of the plurality of elements 105 to a second one of the plurality of elements 105.

The trust boundary represents any transmission of data that crosses from less-to-more or more-to-less trust. Trust boundaries occur when the level of trust associated with the source of a data flow is different from the destination of a data flow. Determining whether the transmission of data crosses a trust boundary comprises, for example, determining whether a level of trust changes from one of the elements 105 to another. There are many types of trust levels. As an example, trust boundaries occur wherever validation, authentication, or authorization should occur. Other examples of trust levels include anonymous data (e.g., data downloaded from a network), authenticated user (e.g., code running as an authenticated user), system (e.g., code running as a part of the operating system), and kernel (e.g., code running with full kernel privileges). When code running as an authenticated user reads data that was downloaded from a network, there is a trust boundary between the two elements 105.

Such operations may lead to vulnerabilities in the application program. For example, the user 106 communicating with a web site represents a trust boundary. Other exemplary trust boundaries include a perimeter firewall, calls from a web application to a database server, and passing fully validated data from business components to data access components. Another exemplary trust boundary exists between user mode and kernel mode. Trust boundaries may be defined in the data flow diagram 104 by a developer of the software, or by the user 106. For example, the user 106 manually marks the location of the trust boundaries on the visual representation of the data flow diagram 104. In such an example, aspects of the invention receive an indication of the trust boundary from the user 106. The indication includes, for example, identification of one of the plurality of elements 105 in the data flow diagram 104.

The external interactor element includes, for example, an external data source communicating with the application program. As an example, the external interactor element is the user 106.

If any of decisions 508, 510, 512, or 514 are negative, then a lower threat priority is assigned for the element 105 at 518. While the assigned threat priorities in FIG. 5 are divided into two categories (e.g., critical and lower priority), aspects of the invention are operable with a range, category, and organization of threat priorities that are assigned based on the criteria 220. After all the elements 105 in the data flow diagram 104 have been analyzed at 520, the assigned threat priorities for the elements 105 are output at 522 to the user 106 for further analysis. The assigned threat priorities indicate potential vulnerabilities in the application program. In some embodiments, the assigned threat priorities for the elements 105 are output at 522 to the user 106 by updating the visual representation of the data flow diagram 104. For example, the assigned threat priorities are visually indicated on the representation by, for example, highlighting, shading, coloring, bolding, or otherwise visually distinguishing some elements from others. For example, elements having a critical threat priority are colored red, elements with lower priorities are colored blue, and elements without an assigned threat priority are colored black.

Decisions 508, 510, 512, and 514 represent examples of the criteria 220 stored in the memory area 204 illustrated in FIG. 2. Other criteria (not shown) are within the scope of the invention. For example, other criteria specify that data flow elements that cross a machine boundary, regardless of other elements 105 connected to the data flow element, be assigned a critical threat priority. Further, decision 512 may be expressed as any form of validation or consistency checking for the element 105 in question. For example, decision 512 may include a determination of whether the element 105 has a source and a destination.

While FIG. 5 illustrates the assignment of a critical threat priority or a lower priority threat priority, other threat priority assignments are within the scope of the invention. For example, the threat priority may be assigned by selecting a threat priority value from a hierarchy of values. For example, the criteria 220 may produce multiple levels of threat priorities.

Referring next to FIG. 6, an exemplary user interface 602 illustrates a data flow diagram with a marked trust boundary 612. In the data flow diagram of FIG. 6, a user 604 communicates with a process 606 via a data flow element 610. The process 606 communicates with a data store 608 to store configuration data (e.g., via a data flow element 607) and to receive results. The trust boundary 612 is between the user 604 and the process 606. The user 604 sends commands to the process 606, and receives responses in return. The sending of commands corresponds to the data flow element 610, and the sending of responses represents another data flow element.

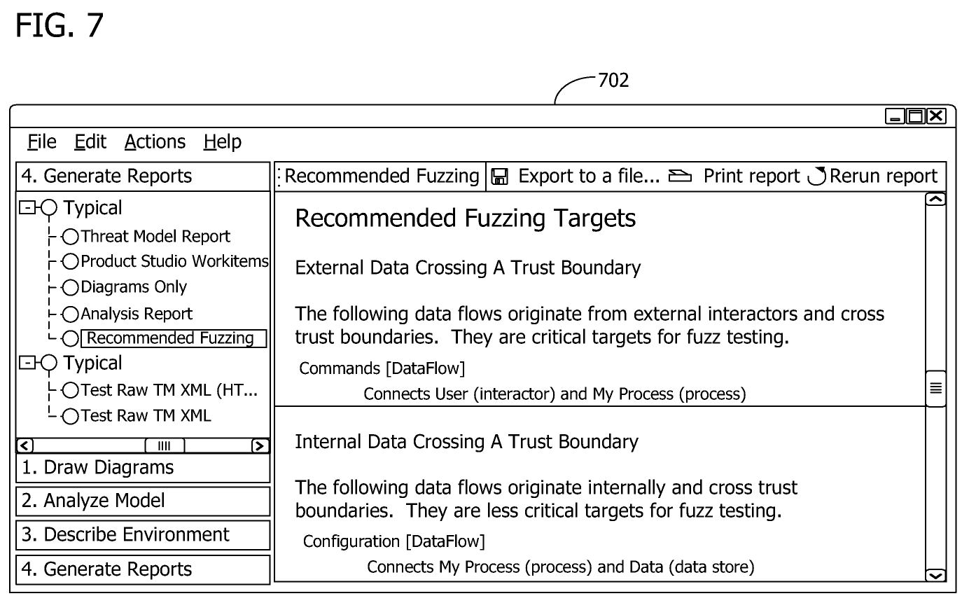

Referring next to FIG. 7, an exemplary user interface 702 illustrates recommend fuzz targets from the data flow diagram illustrated in FIG. 6. In the example of FIG. 7, the recommend fuzz targets are divided into two categories or levels: external data crossing a trust boundary (e.g., critical threat priority) and internal data crossing a trust boundary (e.g., less critical threat priority). The data flow element 610 corresponding to the sending of commands by the user 604 is listed as having a critical threat priority. The data flow element 607 corresponding to the storage of configuration data by the process 606 in the data store 608 is listed as having a less critical threat priority. Based on the information in the user interface 702, the user 604 will concentrate fuzz testing first on data flow element 610, and then on data flow element 607.

### Exemplary Operating Environment

A computer or the computing device 202 such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

The computer may operate in a networked environment using logical connections to one or more remote computers, such as a remote computer. Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

The embodiments illustrated and described herein as well as embodiments not specifically described herein but within the scope of aspects of the invention constitute exemplary means for generating a set of security testing targets representing potential vulnerabilities in the information system, and exemplary means for identifying security testing targets for the information system in a testing environment.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for producing a set of security testing targets in an information system, said system comprising:
a memory area for storing a representation of a data flow diagram for an information system, said data flow diagram comprising a plurality of elements arranged to describe a flow of data through the information system; and
a processor programmed to:
analyze the plurality of elements to identify a data flow element, said identified data flow element representing a transmission of data from a first one of the plurality of elements to a second one of the plurality of elements;
determine whether the transmission of data crosses a trust boundary and whether the first one of the plurality of elements represents an external data source or a data store, said external data source communicating with the information system;
assign a threat priority value to the data flow element based on said determining, said threat priority value indicating a potential vulnerability in the information system; and
provide the identified data flow elements and the assigned threat priority value for the identified data flow element to a user as a security testing target, wherein the user further analyzes the identified data flow element based on the provided threat priority value during security testing.

2. The system of claim 1, wherein the memory area further stores an object model representing the data flow diagram.

3. The system of claim 1, wherein the memory area stores the representation of the data flow diagram according to an extensible markup language.

4. The system of claim 1, wherein the processor is programmed to assign the threat priority value by selecting the threat priority value from a hierarchy of threat priority values.

5. The system of claim 1, further comprising means for generating a set of security testing targets representing potential vulnerabilities in the information system.

6. The system of claim 1, further comprising means for identifying security testing targets for the information system in a testing environment.

7. The system of claim 1, further comprising a user interface for displaying the representation of the data flow diagram to the user, said user interface further displaying the assigned threat priority value to the user.

8. A method comprising:
receiving a representation of a data flow diagram for an information system, said data flow diagram comprising a plurality of elements arranged to describe a flow of data through the information system;
identifying a data flow element from the plurality of elements, said identified data flow element representing a transmission of data from a first one of the plurality of elements to a second one of the plurality of elements;
determining whether the transmission of data crosses a trust boundary; and
indicating the identified data flow element as a potential vulnerability in the information system based on said determining, said indicated data flow element representing a security testing target.

9. The method of claim 8, wherein receiving the representation of the data flow diagram comprises receiving the plurality of elements arranged to represent a flow of data through the plurality of elements.

10. The method of claim 8, wherein determining whether the transmission of data crosses a trust boundary comprises determining whether a level of trust changes between the first one of the plurality of elements and the second one of the plurality of elements.

11. The method of claim 8, wherein determining comprises determining whether the first one of the plurality of elements represents an external data source, said external data source corresponding to a user of the information system.

12. The method of claim 8, further comprising:
assigning a threat priority to the identified data flow element based on said determining; and
updating the representation of the data flow diagram with the assigned threat priority for the data flow element.

13. The method of claim 8, further comprising receiving an indication of the trust boundary from the user, said indication comprising identification of one of the plurality of elements.

14. The method of claim 8, further comprising providing the indicated data flow element to a user as the security testing target.

15. One or more computer-readable media having computer-executable components for identifying security testing targets for an information system in a testing environment, said components comprising:
an interface component for receiving a representation of a data flow diagram for an information system, said data flow diagram comprising a plurality of elements arranged to describe a flow of data through the information system, wherein said interface component further accesses one or more criteria for identifying potential threats to the information system;
a decision component for analyzing each of the plurality of elements based on the criteria accessed by the interface component to identify one or more of the plurality of elements;
a model component for assigning a threat priority to each of the one or more of the plurality of elements identified by the decision component; and
a report component for providing to a user the one or more of the plurality of elements identified by the decision component and the threat priority assigned by the model component as security testing targets.

16. The computer-readable media of claim 15, wherein the report component further sorts the identified one or more of the plurality of elements into a hierarchy of threat levels based on the assigned threat priority.

17. The computer-readable media of claim 16, wherein the report component further prioritizes the one or more of the plurality of elements based on the assigned threat priorities.

18. The computer-readable media of claim 15, wherein the interface component provides the security testing targets to the user in a security testing priority report, wherein the user selects at least one of the security testing targets as a fuzz target for the information system.

19. The computer-readable media of claim 15, wherein the plurality of elements comprises at least two of the following: a data flow element, a data store element, a process, and an external interactor.

20. The computer-readable media of claim 15, wherein the plurality of elements is organized into one or more categories, and wherein the criteria identify at least one of the categories for analysis by the decision component.
